(19) United States
(12) Patent Application Publication
(10) Pub. No.: US 2015/0087571 A1
(43) Pub. Date: Mar. 26, 2015

(54) METHOD OF PREVENTING A FOUL ODOR IN AUTOMOTIVE SERVICE STATIONS

(71) Applicant: Derek Zahajko, Maple Valley, WA (US)

(72) Inventor: Derek Zahajko, Maple Valley, WA (US)

(21) Appl. No.: 14/497,571

(22) Filed: Sep. 26, 2014

Related U.S. Application Data
(60) Provisional application No. 61/882,706, filed on Sep. 26, 2013.

(51) Int. Cl. C11D 3/48; C11D 11/00

(52) U.S. Cl. CPC C11D 3/48; C11D 11/0035
USPC 510/181

(57) ABSTRACT

A method of preventing foul odors in an automotive service station comprising mixing a disinfectant which is effective against bacteria and algae into water used to make a glass cleaner solution which is stored in squeegee buckets in the automobile service station.

### CROSS REFERENCE TO RELATED APPLICATIONS

This application claims the benefit of U.S. provisional application No. 61/882,706 filed on Sep. 26, 2013.

### BACKGROUND OF THE INVENTION

This invention concerns the elimination of a swampy odor to which patrons of automotive service stations are sometimes exposed.

Service stations now typically sell prepared food, and the odors which have sometime been evident in service stations, is particularly off-putting to customers who may be thinking of purchasing food.

Tracing the source of such foul odor is difficult as it could originate from various sources in the station, i.e., drains, rest rooms, spillages, food service, waste receptacles, etc.

Furthermore, the way to abate such an odor is not obvious even when the source of the odor is known.

Since the cleaning solution in a squeegee bucket is typically quickly used up before any odors would be produced and does not usually stay in the bucket for long periods, the possibility that the cleaning solution could be the source of such odor was not widely realized.

While the possibility that such odors might originate from the cleaning solution in a squeegee bucket has been suspected, it was not previously realized why this would be so, and the only remedy previously attempted has been to simply mask the odor with an added pleasant scent. Which measure has not been particularly effective.

It is an object of the present invention to provide a method of eliminating the unpleasant swampy odor sometimes experienced in automotive service stations.

### SUMMARY OF THE INVENTION

The above recited object and other objects which will be understood upon a reading of the following specification and claims have been made possible by the inventors' determination, after extensive studies, that very rapid growth of bacteria and algae in the cleaning solution will occur since the squeegee introduces contaminants therein.

That is, it is believed by the present inventors that various foreign materials such as dirt, grime, bugs, etc. are picked up by the squeegee when used to clean car windows and other surfaces, and are subsequently introduced into the glass cleaning solution in the squeegee bucket when the squeegee is returned to the bucket. The presence of these materials creates a rapid growth of odor causing bacteria and algae in the glass cleaning solution in the bucket which in turn creates the swampy odor to which persons entering a service station are sometimes subjected.

The present inventors have evaluated the effects of adding a disinfecting composition to the glass cleaning solution and determined that the development of such odors emanating from the glass cleaning solutions stored in squeegee buckets is greatly slowed and reduced thereby to an extent eliminating such odor emanating from the squeegee buckets.

A particularly effective disinfectant is polyquartenary ammonium sold as WSCP by Finoric LLC of Houston and Midland Tex.

An effective amount of that disinfectant has been found to be on the order of about one half pound of WSCP per 1000 gallons of water to prevent the growth of bacteria and algae in the glass cleaning solution.

### DESCRIPTION OF THE DRAWING

FIG. 1 is a pictorial view of a typical service station having squeegee buckets.

FIG. 2 is a pictorial enlarged view of a typical squeegee and squeegee bucket used in automotive service stations.

FIG. 3 is a comparative plot of bacteria growth over time in several samples of glass cleaning solutions with one sample including the addition of an effective amount of disinfectant and the rest not having any disinfectant added to the glass cleaning solutions.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

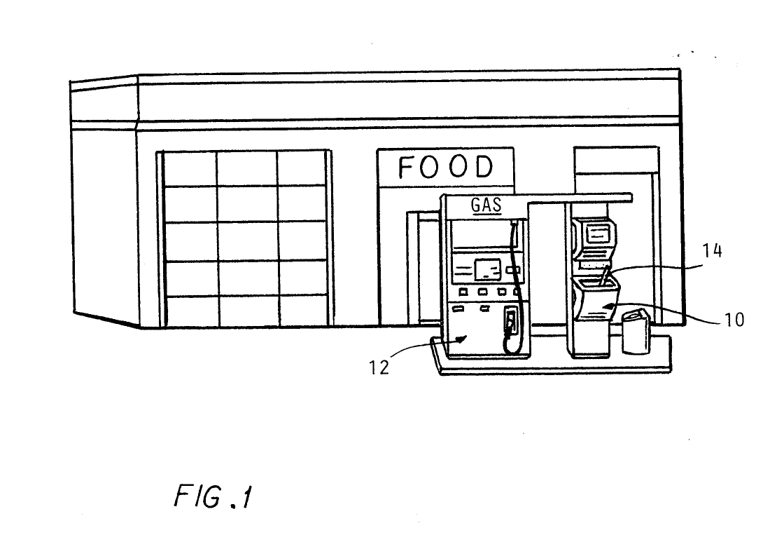

Referring to the drawings, automotive service stations such as depicted in FIG. 1 normally provide one or more squeegee buckets 10 mounted adjacent the fuel delivery pumps 12 to be conveniently accessed by patrons purchasing gasoline allowing them to clean the windows of their automobile.

The squeegee buckets 10 are open topped so as to allow a squeegee 14 to be dipped into a glass cleaning solution therein, the squeegee 14 replaced and left in the squeegee bucket 10 after its use to clean the windows, in the well known manner.

The glass cleaning solution used typically contains detergents and perhaps water softening agents and is normally free from contaminants when added to the squeegee bucket 10.

It was not realized that such solutions support substantial bacterial growth in the relatively short period before being replenished with fresh solution.

It is believed that for this reason the odor problem described above has heretofore persisted for decades prior to the development of the present invention.

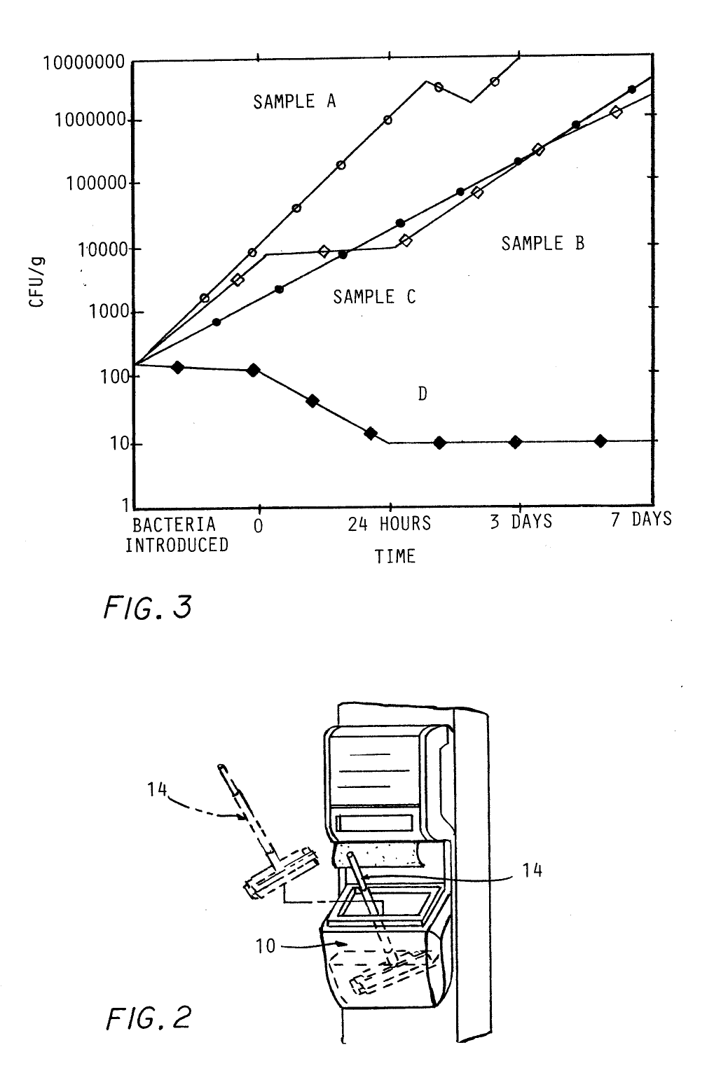

However, when the squeegees 14 is used to clean the windows, foreign material is picked up from the dirty surfaces particularly in the squeegee foam pad used to apply the cleaning solution, and is introduced into the cleaning solution by the squeegee being replaced in the bucket 10 and left there for some time (FIG. 2).

This action is believed to result in the introduction and growth of bacteria and/or algae sufficiently rapidly to generate odor after only a relatively short time.

According to the present invention, this situation is avoided by mixing a disinfectant into the glass cleaning solution to be added to prevent the growth of common bacteria and/or algae causing the generation of odor.

Such disinfectants suitable for this application are commercially available. One such disinfectant is quaternary ammonium which is sold by Finoric LLC of Houston and Midland Tex., referred to by Finoric as Poly Quaternium WSCP.

This composition has been found to be effective mixed into the water in the glass cleaning solution at the rate of 0.4725 pounds per 1000 gallons of water, i.e., approximately one half pound per 1000 gallons water.

FIG. 3 is a plot of CFU/gv time for four samples (CFU is the colony forming unit used in microbiology). The plot is logarithmic, i.e., one interval increase equals ten times more bacteria.

Sample D is a glass cleaning solution with the added disinfectant, and Samples A-C are plots of three different commercially used cleaning solutions which do not include a disinfectant.

It can be seen that there is a very rapid growth of bacteria in the Samples A-C of cleaning solutions without a disinfectant, with substantial growth taking place in a matter of hours.

A marked reduction of bacteria is seen in the Sample D plot persisting over seven days.

1. A method of preventing foul odors in automotive service stations having a glass cleaner solution stored in an open topped squeegee bucket for use by its patrons to clean windows of an automobile, comprising mixing a disinfectant in an effective amount in water used to make a glass cleaner solution to substantially stop the growth of bacteria and algae in said glass cleaner solution.

2. The method according to claim 1 wherein said disinfectant is quaternary ammonium mixed in water in a proportion of approximately one half pound per 1000 gallons of water.
